(19) United States
(12) Patent Application Publication
(10) Pub. No.: US 2009/0031844 A1
(43) Pub. Date: Feb. 5, 2009

(54) TILT-TYPE STEERING APPARATUS

(75) Inventors: Masato Iwakawa, Gunma (JP); Osamu Tatewaki, Gunma (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 12/282,248

(22) PCT Filed: Jan. 21, 2008
(86) PCT No.: PCT/JP2008/050712

§ 371 Date: Sep. 9, 2008

(30) Foreign Application Priority Data
Feb. 28, 2007 (JP) 2007-050133

(51) Int. Cl. B62D 1/18

(52) U.S. Cl. 74/493

(57) ABSTRACT

A tilt-type steering apparatus includes a steering column swingably supported by a tilt pivot shaft and rotatably supporting a steering shaft to which a steering wheel is attached, and a tilt bracket fixed to a vehicle body member and tiltably holding the steering column Stress cushioning member is disposed between the steering column and the tilt bracket.

### TECHNICAL FIELD

The present invention is related to a tilt-type steering apparatus having a steering column which rotatably supports a steering shaft to which a steering shaft is attached, and a tilt bracket which tiltably supports the steering column.

### BACKGROUND ART

Conventionally, there has been known an electric position adjusting type steering column apparatus as an example of tilt-type steering apparatuses, in which a rectangular supporting portion is formed around a steering column, abutting plates (slide plates) are interposed between the supporting portion and opposing flat plate portions of a vehicle body side bracket, and a plurality of fastening screws are fastened to press the abutting plates from right and left against the rectangular supporting portion of the steering column, thereby providing sliding resistance between the supporting portion and the opposing flat plate portions of the steering vehicle body side bracket. The sliding resistance is set to be greater than an external input from a steering wheel (a steering force from a driver) but smaller than tilt driving force. Patent Document 1: JP 2005-199760 A (page 1, FIG. 3)

### DISCLOSURE OF THE INVENTION

### Problems to be Solved by the Invention

However, in the conventional example disclosed in Patent Document 1 in which the sliding resistance is provided between the rectangular supporting portion of the steering column and the opposing flat plate portions of the vehicle body side bracket sandwiching the rectangular supporting portion of the steering column, if there is an misalignment in a parallelism between the steering column and the opposing flat plate portions of the vehicle body side bracket, assembling is carried out such that the steering column is dented due to a partial contact against the opposing flat plate portions of the vehicle body side bracket (not a uniform contact of the entire contact surface by a local contact). When adjusting a position of the steering column under such a condition that the steering column is partially contacting against the opposing flat plate portions of the vehicle body side bracket, there have been some unsolved problems such as an occurrence of abnormal noise and an increase of a drive current of an electric actuator, resulting from scratching on the sliding surface and running out of lubricant oil on the sliding surface.

In order to solve such unsolved problems, a method for improving a dimensional accuracy of the vehicle body side bracket and the vehicle body to improve the parallelism between the steering column and the opposing flat plate portions of the vehicle body side bracket may be conceived. In such a case, however, it is necessary to improve dimensional accuracy of each of the components, which would then result in another problem of increase of manufacturing cost.

The present invention has been made in view of the unsolved problems of the conventional example described above, and it is an object thereof to provide a tilt-type steering apparatus in which a damage of a sliding surface and an occurrence of an abnormal noise upon position adjustment can be prevented even under the condition of partial contact between a steering column and a vehicle body side bracket, without need of improving dimensional accuracy of each of the components.

### Means for Solving the Problems

In order to achieve the object described above, a tilt-type steering apparatus according to a first aspect of the present invention includes a steering column swingably supported by a tilt pivot shaft and rotatably supporting a steering shaft to which a steering wheel is attached; and a tilt bracket fixed to a vehicle body member and tiltably holding the steering column,

wherein a stress cushioning member is disposed between the steering column and the tilt bracket.

According to the tilt-type steering apparatus of a second aspect, in the first aspect of the invention, the stress cushioning member is made of a synthetic resin.

Further, according to the tilt-type steering apparatus of a third aspect, in the first aspect of the invention, the stress cushioning member is fixed on either one of the steering column and the tilt bracket.

Further, according to the tilt-type steering apparatus of a fourth aspect, in the first aspect of the invention, a fitting recess is formed on either one of the steering column and the tilt bracket; and the stress cushioning member is fixedly fitted into the fitting recess.

Still further, according to the tilt-type steering apparatus of a fifth aspect, in the first aspect of the invention, a fitting recess is formed on either one of the steering column and the tilt bracket; and a fitting protrusion formed on the stress cushioning member is fitted into the fitting recess.

Still further, according to the tilt-type steering apparatus of a sixth aspect, in the first aspect of the invention, a fitting protrusion is formed on either one of the steering column and the tilt bracket, and a fitting recess formed on the stress cushioning member is fitted into the fitting protrusion.

Still further, according to the tilt-type steering apparatus of a seventh aspect, in the first aspect of the invention, the tilt-type steering apparatus further includes an electric actuator which tilts the steering column with respect to the tilt bracket.

### ADVANTAGES OF THE INVENTION

According to the present invention, the stress cushioning member is disposed between the steering column and the tilt bracket. Therefore, even if the dimension accuracy as to the steering column, the tilt bracket, and the vehicle body member is low so that a partial contact is created between the steering column and the stress cushioning member or between the stress cushioning member and the tilt bracket, the stress cushioning member conforms to a sliding surface contacting thereto over time so that an area of the sliding surface increase, whereby surface pressure on the sliding surface is reduced. The reduction of the surface pressure on the sliding surface is advantageous in that damages and running out of lubricating oil of the sliding surface can be prevented, and also, abnormal noise generation and an increase of drive current in a case where a electric actuator is provided can be prevented. Moreover, it is also advantageous in that the manufacturing cost can be reduced because it is not required to improve the dimensional accuracy of respective components.

### BRIEF DESCRIPTION OF THE DRAWINGS

FIG. 1 is an entire structural view showing a state in which a steering apparatus according to the present invention is mounted on a vehicle.

FIG. 2 is a left side view of a steering column apparatus from which a steering wheel is removed.

FIG. 3 is a front view showing an example of a tilt bracket with a section of a steering column.

FIG. 4 is a sectional view taken along the line A-A of FIG. 2, showing a electric tilting mechanism.

FIG. 5 is a sectional view taken along the line B-B of FIG. 4.

FIG. 6 is a front view showing another example of an outer column, wherein (a) is a front view of a state in which stress cushioning members are separated, and (b) is another front view of a state in which the stress cushioning members are attached.

FIG. 7 is a front view showing yet another example of an outer column, wherein (a) is a front view of a state in which stress cushioning members are separated, and (b) is another front view of a state in which the stress cushioning members are attached.

FIG. 8 is a front view, which is similar to FIG. 3, of a tilt bracket according to a second embodiment of the present invention.

FIG. 9 is a front view of a tilt bracket according to a modified example of the second embodiment, showing a state in which stress cushioning members are separated.

FIG. 10 is another front view of the tilt bracket according to the modified example of the second embodiment, showing a state in which the stress cushioning members are fixed.

FIG. 11 is a front view of a tilt bracket according to another modified example of the second embodiment, showing a state in which stress cushioning members are separated.

FIG. 12 is another front view of the tilt bracket according to the other modified example of the second embodiment, showing a state in which the stress cushioning members are fixed.

### EXPLANATION OF REFERENCE NUMERALS

10—steering column apparatus, 11—steering shaft, 12—steering column, 12a—outer column, 12b—inner column, 12c, 12d—projected portion, 13—steering wheel, 14, 16—universal joint, 15—intermediate shaft, 17—steering gear, 18—tie rod, 19—steered wheel, 21—vehicle body member, 24—tilt bracket, 24b—attaching plate portion, 24c, 24d—guide plate portion, 24e—bottom plate portion, 24g—clearance filling plate, 25a, 25b—stress cushioning member, 26a, 26b—fitting recess, 27a, 27b—fitting recess, 28a, 28b—fitting protrusion, 30—electric tilting mechanism, 50—electric telescopic mechanism, 61a, 61b—fitting recess 62a, 62b—fitting hole portion, 63a, 63b—fitting protrusion

### BEST MODE FOR CARRYING OUT THE INVENTION

Hereinafter, embodiments of the present invention will be described with reference to the drawings.

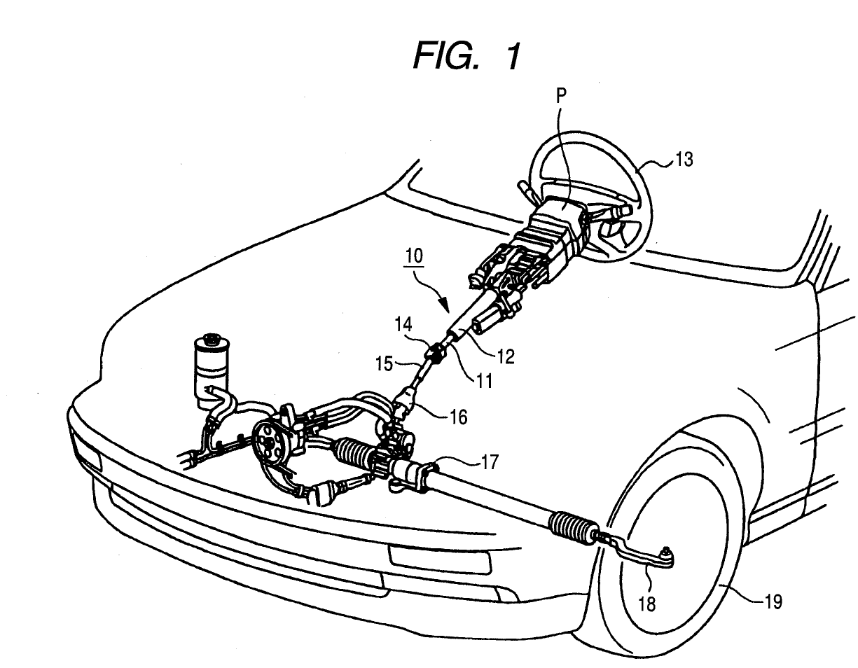

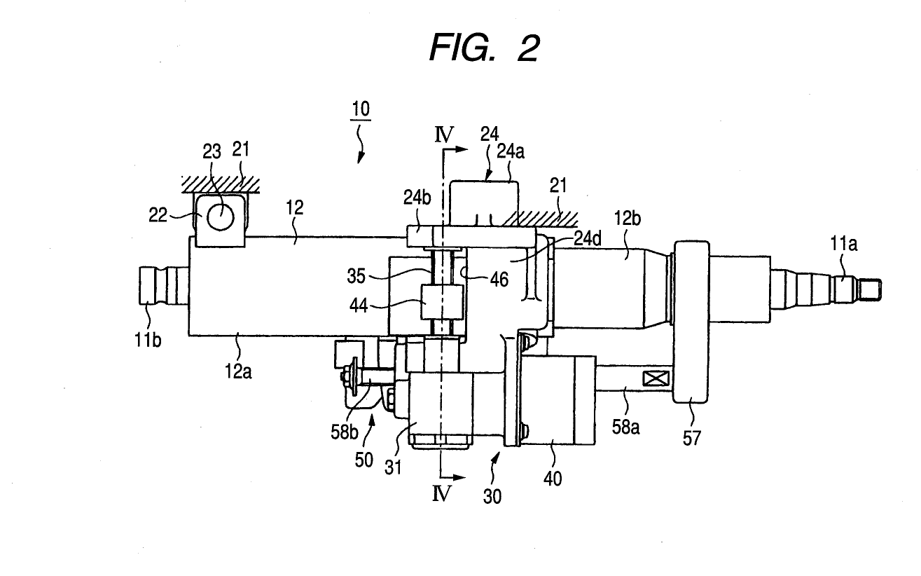

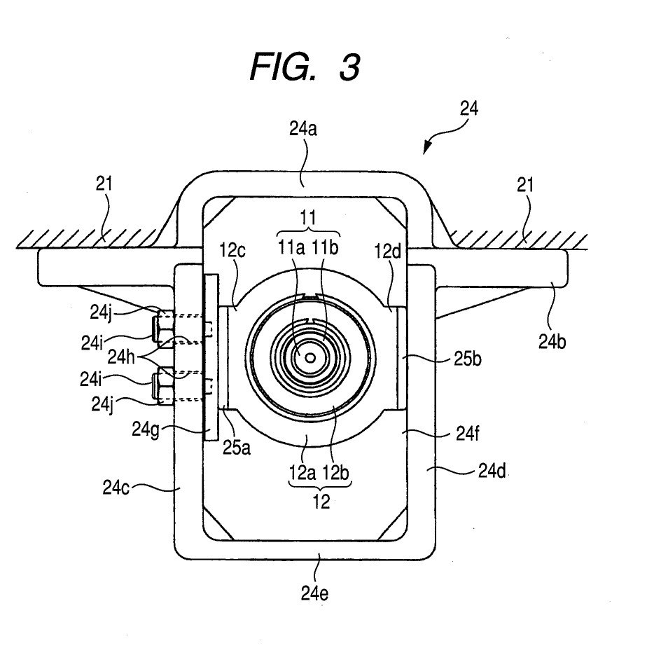

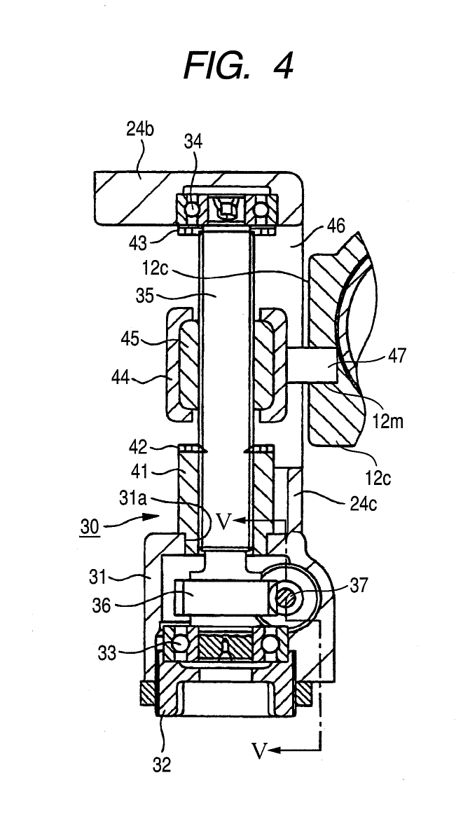

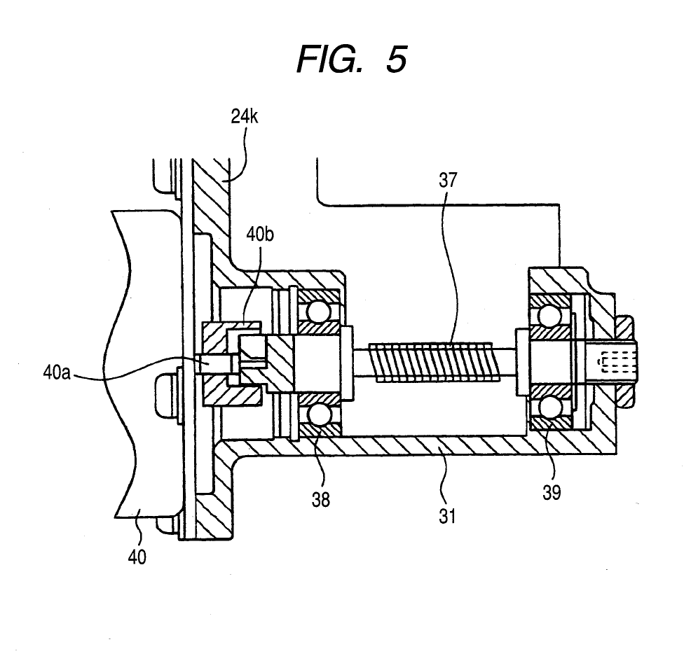

FIG. 1 is an entire structural view showing a vehicle into which a steering apparatus according to the present invention is incorporated, FIG. 2 is a left side view showing a steering apparatus according to a first embodiment of the present invention, FIG. 3 is a front view of a tilt bracket, FIG. 4 is a sectional view taken along the line A-A of FIG. 2 and showing a electric tilting mechanism, and FIG. 5 is a sectional view taken along the line B-B of FIG. 4.

In FIG. 1, a steering column apparatus 10 has a steering column 12 which rotatably supports a steering shaft 11. The steering shaft 11 has a rear end to which a steering wheel 13 is attached and a front end to which an intermediate shaft 15 is coupled via a universal joint 14. The intermediate shaft 15 has a front end to which a steering gear 17, including a rack-and-pinion mechanism, is coupled via another universal joint 16. An output shaft of the steering gear 17 is coupled to a steered wheel 19 via a tie rod 18.

When a driver steers the steering wheel 13, a rotation force thereof is transmitted to the steering gear 17 via the steering shaft 11, the universal joint 14, the intermediate shaft 15 and the universal joint 16, and a rotational movement is converted into a linear movement along a vehicle width direction through the rack-and-pinion mechanism, whereby the steered wheel 19 is turned via the tie rod 18.

Peripheral components P is arranged on a rear portion of the steering column 12. The peripheral components P includes such as a control switch and a combination switch for driving an electric tilting mechanism 30 and an electric telescopic mechanism 50 which will be described later, and a column cover.

As shown in FIGS. 2 and 3, the steering column apparatus 10 includes the steering shaft 11 to which the steering wheel 13 is attached, and the steering column 12 which rotatably supports the steering shaft.

The steering column 12 includes an outer column 12a, and an inner column 12b which is slidably held by the outer column 12a. The steering shaft 11 is rotatably supported by rolling bearings (not shown) which are arranged on inner circumferential surfaces of front and rear end portions of the inner column 12b respectively.

As shown in FIGS. 2 and 3, the steering column 12 includes the outer column 12a, and the inner column 12b which is slidably held by the outer column 12a. The outer column 12a has a rear end (a left end in FIG. 2) which is on a side of the universal joint 14 and a front end (a right end in FIG. 2) which is on a side of the steering wheel 13. The rear end of the outer column 12 is supported by a tilt pivot shaft 23 on a lower bracket 22, which is attached to a vehicle body member 21, so as to be swingable in up-and-down directions. The front end of the outer column 12 is supported by a tilt bracket 24, which is attached to the vehicle body member 21, so as to be movable in the up-and-down directions.

As shown in FIG. 3, the tilt bracket 24 includes an attaching plate portion 24b, guide plate portions 24c, 24d, and a bottom plate portion 24e, thereby forming a rectangular frame shape. The attaching plate portion 24b has a bulged portion 24a which is upwardly protruded in a central portion to be attached to the vehicle body member 21. The guide plate portions 24c, 24d extend downwardly from right and left positions of the bulged portion 24a of the attaching plate portion 24b respectively. The bottom portion 24e couples lower end portions of the respective guide plate portions 24c, 24d.

The outer column 12a is inserted through a guide space 24f which is surrounded by the attaching plate portion 24b, the guide plate portions 24c, 24d, and the bottom plate portion 24e of the tilt bracket 24.

As shown in FIG. 3, the outer column 12a is formed with projected portions 12c, 12d which are horizontally projected from right and left sides respectively and each of which having a flat end face. Stress cushioning members 25a, 25b, each having a rectangular solid shape, are fixed on the respective projected portions 12c, 12d as slidably contacting portions on respective projected sides.

The stress cushioning members 25a, 25b are formed of synthetic resin having high abrasion resistance, such as POM (polyacetal) resin, PA (polyamide) resin, PEEK (polyetheretherketone) resin, PPS (polyphenylene sulfide) resin, PAI (polyamide-imide) resin, PTFE (4-ethylene fluoride) or the like. The stress cushioning members 25a, 25b are fixed on the projected portions 12c, 12d by adhesive bonding, welding or the like. In order to further improve slidability (durability) of the stress cushioning members 25a, 25b, for example, oil impregnated resin such as oil impregnated POM resin may be used.

One of the stress cushioning members 25a is slidably contacted to a clearance filling plate 24g which is arranged on an inner side surface of the guide plate portion 24c of the tilt bracket 24 to prevent a play of the steering column 12, while the other of stress cushioning members 25b is slidably contacted to an inner side surface of the guide plate portion 24d of the tilt bracket 24.

As shown in FIG. 3, the clearance filling plate 24g has a pair of projection adjusting bolts 24i which is screwed into a pair of female screws 24h formed through the guide plate portion 24d with a certain interval in the up-and-down directions therebetween. A projecting length of the clearance filling plate 24g from the inner circumferential surface of the guide plate portion 24d is adjustable with the pair of projection adjusting bolts 24i, and the adjusted projecting length is maintained by screwing locking nuts 24j onto the projection adjusting bolts 24i.

The steering column 12 is held by the electric tilting mechanism 30, which is arranged on a vehicle-front side (the left side in FIG. 2) of the guide plate portions 24c, 24d of the tilt bracket 24, so as to be movable in the up-and-down directions. As shown in FIG. 4, the electric tilting mechanism 30 has a screw shaft 35 which is rotatably supported by a rolling bearing 33 and another rolling bearing 34 and extending along the guide plate portion 24c in the up-and-down directions. The rolling bearing 33 is fixedly arranged on a holding member 32 inside a gear housing 31. The gear housing 31 is integrally formed on a lower end portion of the guide plate portion 24c of the tilt bracket 24 and has a substantially rectangular frame shape. The other rolling bearing 34 is arranged on a lower surface of the attaching plate portion 24b of the tilt bracket 24.

A worm wheel 36 is attached to the screw shaft 35 at a position near the rolling bearing 33 inside the gear housing 31, and a worm 37 is meshed with the worm wheel 36. As shown in FIG. 5, this worm 37 is rotatably held by rolling bearings 38, 39 arranged inside the gear housing 31, and one end of the worm 37 is coupled, via a coupling 40b, to an output shaft 40a of an electric motor 40 which is fixed on an attaching plate portion 24k formed on the guide plate portion 24c of the tilt bracket 24.

A cylindrical covering member 41 is arranged on an inner side of a through hole 31a, through which the screw shaft 35 is inserted, of the gear housing 31 to cover the screw shaft 35, and a damper 42 is arranged on a tip portion of the cylindrical covering member 41. The damper 42 is made of synthetic resin having high elasticity such as polyurethane, and is slidably contacted to an outer circumferential surface of the screw shaft 35. Similarly, another damper 43 is arranged on a lower end face of the rolling bearing 34, and is slidably contacted to the outer circumferential surface of the screw shaft 35.

A nut 45 is screwed onto the screw shaft 35 between the dampers 42, 43, and is held by a nut holder 44 having a rectangular section. The nut holder 44 is engaged within a guide groove 46, which is formed in the guide plate portion 24c of the tilt bracket 24 and extending along the up-and-down directions. An engaging pin 47, which is protrudingly formed from the nut holder 44, is engaged with a slot 12m, which is formed to extend along an axial direction in the protrusion 12c integrally formed with the outer column 12a. Accordingly, a rotation of the nut holder 44 around a center axis of the screw shaft 35 is restricted, whereby the nut holder 44 moves along the up-and-down directions in accordance with a rotation of the screw shaft 35 in forward and reverse directions.

Therefore, when the electric motor 40 drives the worm 37 in forward and reverse directions, the screw shaft 35 is driven in the forward and reverse directions so that the nut holder 44 is moved along the up-and-down directions and the outer column 12a is swung in the up-and-down directions around the tilt pivot shaft 23, whereby a tilting function can be exercised. An electric actuator 48 includes the electric motor 40, the worm 37, the worm wheel 36, the screw shaft 35 and the nut 45.

An electric telescopic mechanism 50 is provided between the outer column 12a and the inner column 12b of the steering column 12.

This electric telescopic mechanism 50 has a coupling plate portion 57 and a coupling rod 58. The coupling plate portion 57 is attached to the inner column 12b on a side of the steering wheel (a right end side in FIG. 2). The coupling rod 58 has an outer shaft 58a coupled to the coupling plate portion 57, and an inner shaft 58b coupled to the outer shaft 58a. A male screw is formed in an outer circumferential surface of the inner shaft 58b, and a worm wheel (not shown) is meshed with this male screw. When a worm meshed with the worm wheel is rotatably driven by an electric motor (not shown), the inner shaft 58b is linearly moved in along the axial direction of the steering column 12 such that the inner column 12b is moved back and forth with respect to the outer column 12a, whereby a telescopic adjustment is performed.

Next, operations of the above-described embodiment will be explained.

Now, when a driver carries out a tilt adjustment of the steering column 12 of the steering column apparatus 10, a control switch provided in the peripheral components P, which is arranged on the rear side of the steering column 12 as shown in FIG. 1, for the tilt mechanism is operated in a tilt-up direction (or in a tilt-down direction) to drive the electric motor 40 of the electric tilting mechanism 30, for example, in the forward direction (or in the reverse direction).

In response thereto, the screw shaft 35 is driven in the reverse direction (or in the forward direction) via the worm 37 and the worm wheel 36 so that the nut 45 is moved upwardly (or downwardly) as viewed in FIG. 4. Because the engaging pin 47 formed on the nut holder 44 is engaged with the slot 12m formed on the projected portion 12c of the outer column 12a, the outer column 12a is rotated upwardly (or downwardly) around the tilt pivot shaft 23, whereby the tilt-up adjustment (or the tilt-down adjustment) can be performed. If there is a misalignment in a parallelism between the slidably contacting surfaces of the steering column 12 and the tilt bracket 24, the stress cushioning members 25a, 25b are brought into such a condition that they partially contact against the clearance filling plate 24g and the guide plate portion 24d at the time of assembling However, because the stress cushioning members 25a, 25b are attached to the respective projecting end portions of the projected portions 12c, 12d formed on the outer column 12a of the steering column 12 and are slidably contacted to the inner side surface of the guide plate portion 24d of the tilt bracket 24 and the clearance filling plate 24g, the stress cushioning members 25a, 25b conform to the slidably contacting surfaces of the clearance filling plate 24g and the guide plate portion 24d over time so that an area of the slidably contacting surfaces increases, whereby a surface pressure of the slidably contacting surface can be reduced.

Reduction of the surface pressure of the slidably contacting surface reliably prevents damages and running out of lubricating oil with respect to the slidably contacting surfaces, and also prevents an abnormal noise and an increase of drive current for driving the electric motor 40 of the electric tilting mechanism 30 at the time of sliding contact. In addition, because the dimensional accuracy is no longer required to be improved, it is possible to reduce the manufacturing cost.

Moreover, because the stress cushioning members 25a, 25b are attached to the projected portions 12c, 12d of the outer column 12a, lengths of the respective stress cushioning members 25a, 25b along the sliding direction can be made to be the same as the lengths of the projected portions 12c, 12d. Accordingly, the lengths of the stress cushioning members 25a, 25b can be designed to be necessary minimum lengths.

When the driver carries out a telescopic adjustment of the steering column 12 of the steering column apparatus 10, a control switch provided in the peripheral component P, which is arranged on the rear side of the steering column 12 as shown in FIG. 1, for the telescopic mechanism is operated in an extending direction (or a compressing direction), to drive the electric motor (not shown) of the electric telescopic mechanism 50 in the forward direction (or in the reverse direction), whereby the coupling rod 58 is moved along the axial direction of the steering column 12 to extend or compress the inner column 12b with respect to the outer column 12a via the coupling plate portion 57 so that the telescopic adjustment can be performed.

In the first embodiment described above, the description has been made of a case in which the stress cushioning members 25a, 25b are adhered or welded to the projected portions 12c, 12d of the outer column 12a. However, the present invention is not limited thereto. The stress cushioning members 25a, 25b may be fixed by other fixing means such as screws.

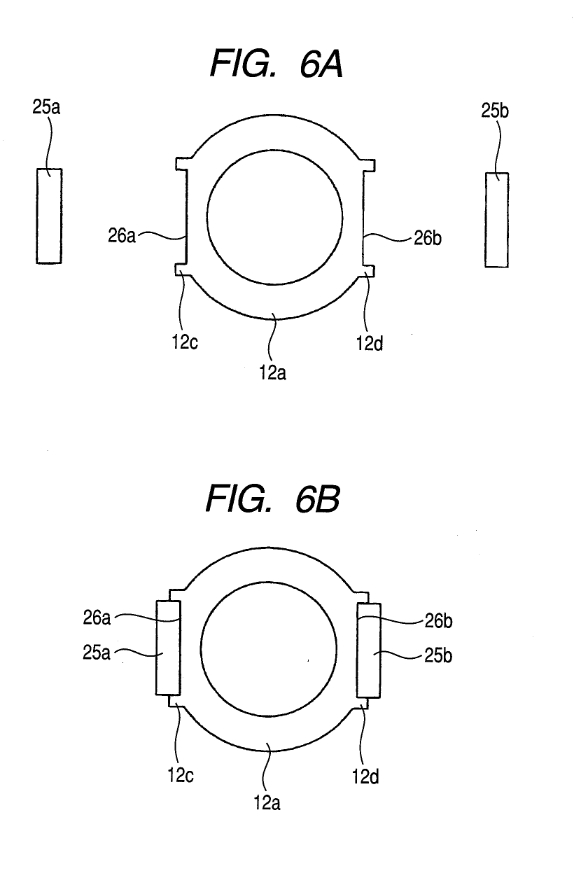

Further, in the first embodiment, the description is made of a case in which the stress cushioning members 25a, 25b are attached to the flat end surfaces of the projected portions 12c, 12d of the outer column 12a. However, the present invention is not limited thereto. As shown in FIG. 6(a) illustrating a state in which the outer column 12a and the stress cushioning members 25a, 25b are separated and in FIG. 6(b) illustrating a state in which they are attached together, fitting recesses 26a, 26b having large areas may be formed on the end surfaces of the projected portions 12c, 12d so that the stress cushioning members 25a, 25b are fitted into the fitting recesses 26a, 26b respectively so as to be attached. According to such a configuration, because the stress cushioning members 25a, 25b are fitted inside the fitting recesses 26a, 26b formed on the projected portions 12c, 12d of the outer column 12a, the stress cushioning members 25a, 25b are firmly held by the projected portions 12c, 12d. Accordingly, it is possible to reliably prevent the stress cushioning members 25a, 25b from being removed when titling the outer column 12a.

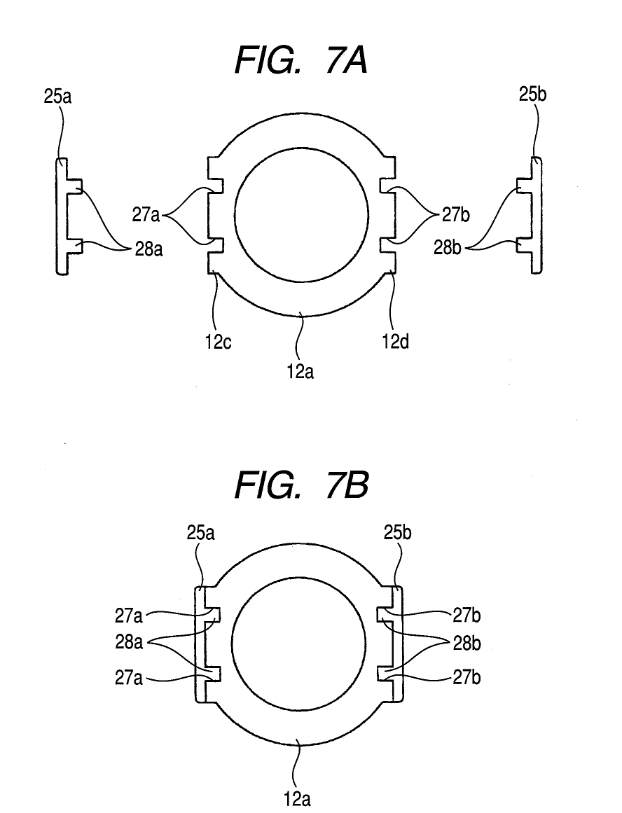

Further, as shown in FIG. 7(a) illustrating a state in which the outer column 12a and the stress cushioning members 25a, 25b are separated and in FIG. 7(b) illustrating a state in which they are attached together, a pair of fitting recesses 27a, 27b having small areas may be formed on the end surfaces of the projected portions 12c, 12d respectively and fitting protrusions 28a, 28b fittable into the respective fitting recesses 27a, 27b may be formed on the stress cushioning members 25a, 25b. In such a case, as shown in FIG. 7(b), the stress cushioning members 25a, 25b are attached to the projected portions 12c, 12d of the stress cushioning members 25a, 25b by fitting the fitting protrusions 28a, 28b of the stress cushioning members 25a, 25b into the respective fitting recesses 27a, 27b formed on the projected portions 12c, 12d. Sectional shapes of the fitting recesses 27a, 27b and the fitting protrusions 28a, 28b may be any shapes such as a circular shape or a rectangular shape extending in the axial directions, and the respective numbers of the fitting recesses and the fitting protrusions is not restricted and may be four by adding two along the axial direction respectively.

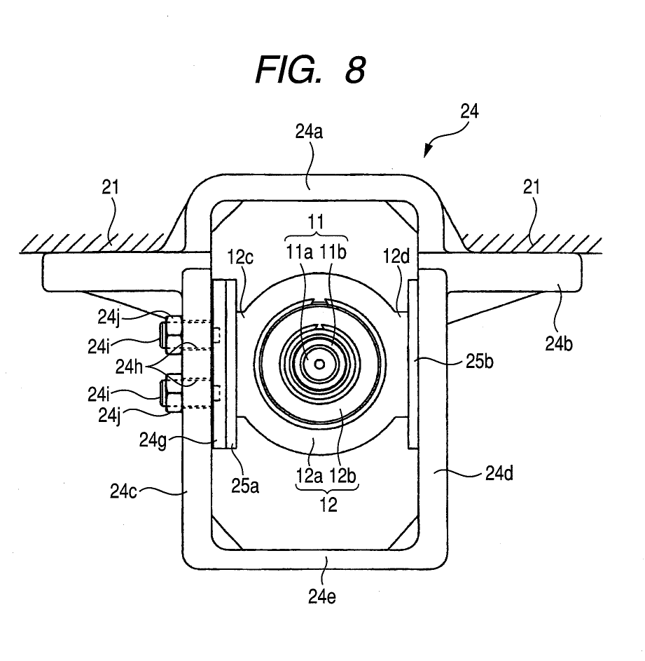

Next, a second embodiment of the present invention will be explained with reference to FIG. 8. FIG. 8 is a sectional view which is similar to the sectional view of FIG. 3 of the first embodiment.

In this second embodiment, the stress cushioning members 25a, 25b are fixed to the tilt bracket 24.

That is, as shown in FIG. 8, a configuration of the second embodiment is similar to that of the first embodiment except that the stress cushioning members 25a, 25b are fixed onto a flat inner side surface of the clearance filling plate 24g and a flat inner side surface of the guide plate portion 24d of the tilt bracket 24 with fixing means such as adhesive bonding, welding and screw fixing or the like. As for the portions corresponding to those in FIG. 3, detailed description will be omitted by denoting with the same reference numerals.

In this case, lengths of the stress cushioning members 25a, 25b along the up-and-down directions are set to correspond to a tilt adjusting range of the steering column 12.

According to the second embodiment, the stress cushioning members 25a, 25b are fixed to the clearance filling plate 24g and the guide plate portion 24d, and the flat end surfaces of the projected portions 12c, 12d of the outer column 12a are slidably contacted to the stress cushioning members 25a, 25b. Therefore, similar advantageous effects similar as the first embodiment can be contained.

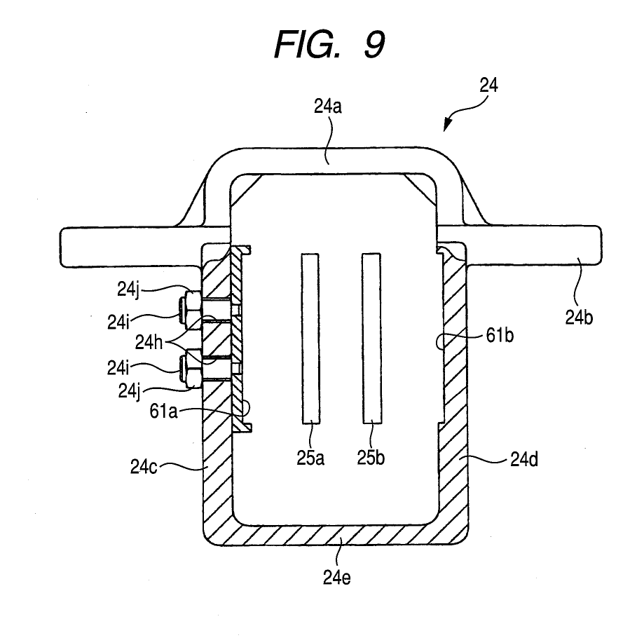

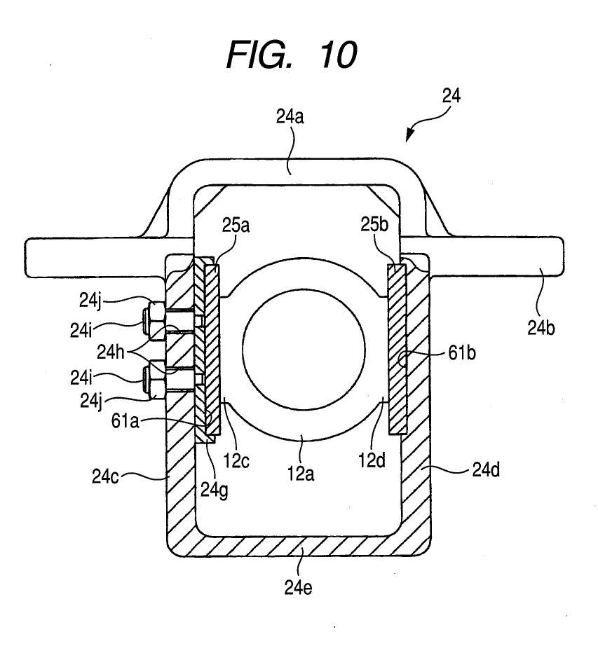

While the description has been made of a case in which the stress cushioning members 25a, 25b are fixed onto the flat inner side surface of the clearance filling plate 24g and the flat inner side surface of the guide plate portion 24d of the tilt bracket 24 in the second embodiment, the present invention is not restricted thereto. As shown in FIG. 9 illustrating a state in which the outer column 12a and the stress cushioning members 25a, 25b are separated and in FIG. 10 illustrating a state in which they are attached together, fitting recesses 61a, 61b having large areas may be formed on the inner side surface of the clearance filling plate 24g and the inner side surface of the guide plate portion 24d so that the stress cushioning members 25a, 25b are fitted into these fitting recesses 61a, 61b so as to be attached. According to this configuration, because the stress cushioning members 25a, 25b are fitted into the fitting recesses 61a, 61b formed on the inner side surface of the clearance filling plate 24g and the inner side surface of the guide plate portion 24d so that the stress cushioning members 25a, 25b are firmly held by the clearance filling plate 24g and the guide plate portion 24d, it is possible to reliably prevent the stress cushioning members 25a, 25b from being removed when tilting the outer column 12a.

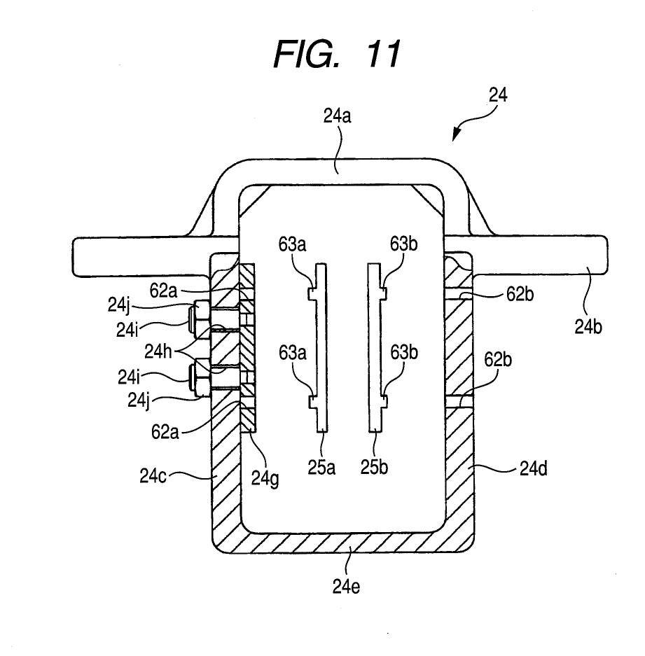

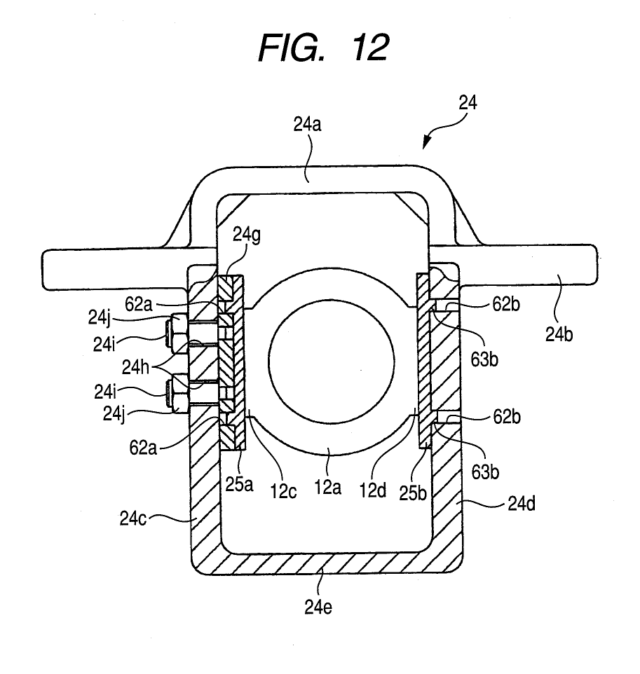

Further, as shown in FIG. 11 illustrating a state in which the outer column 12a and the stress cushioning members 25a, 25b are separated and in FIG. 12 illustrating a state in which they are attached together, fitting hole portions 62a, 62b having small areas may be formed on the inner side surface of the clearance filling plate 24g and the inner side surface of the guide plate portion 24d as a pair of fitting recesses respectively, and fitting protrusions 63a, 63b to be fitted into the fitting hole portions 62a, 62b may be formed on the respective stress cushioning members 25a, 25b, so that the stress cushioning members 25a, 25b are fixed to the clearance filling plate 24g and the guide plate portion 24d by fitting the fitting protrusions 63a, 63b of the stress cushioning members 25a, 25b into the fitting hole portions 62a, 62b formed on the clearance filling plate 24g and the guide plate portion 24d as shown in FIG. 13. The fixing hole portions 62a, 62b may alternatively have bottoms so as to be fixing recesses respectively. Further, such fitting protrusions may be formed on the inner side surface of the clearance filling plate 24g and the inner side surface of the guide plate portion 24d, and fitting recesses to be fitted to the fitting protrusions may be formed on the stress cushioning members 25a, 25b. Furthermore, a fitting recess may be formed on one of the stress cushioning members 25a, 25b, for example, on the stress cushioning member 25a and a fitting protrusion may be formed on the other stress cushioning member 25b, while corresponding fitting protrusion and fitting recess may be formed on the inner end surface of the clearance filling plate 24g and in the inner end surface of the guide plate portion 24d facing the stress cushioning members 25a, 25b.

Furthermore, while the first and second embodiments have been explained that both of the stress cushioning members 25a, 25b are fixed on the outer column 12a or on the clearance filling plate 24g and the guide plate portion 24d, the present invention is not restricted thereto. Alternatively, the stress cushioning member 25a may be fixed on the clearance filling plate 24g and the other stress cushioning member 25b may be fixed on the projected portion 12d of the outer column 12a. Conversely, the stress cushioning member 25a may be fixed on the projected portion 12c of the outer column 12a and the other stress cushioning member 25b may be fixed on the guide plate portion 24d. Moreover, one of the right and left stress cushioning members 25a, 25b may be omitted.

It should also be noted that, while the first and second embodiments have been explained that the present invention is applied to the steering apparatus having the electric tilting mechanism 30, the present invention is not restricted thereto, and may also be applied to a steering apparatus having a general manual tilt mechanism without the electric tilting mechanism 30.

The present application is based on Japanese Patent Application No. 2007-050133 filed on Feb. 28, 2007, the content of which is incorporated herein by reference.

1. A tilt-type steering apparatus comprising:
a steering column swingably supported by a tilt pivot shaft and rotatably supporting a steering shaft to which a steering wheel is attached; and
a tilt bracket fixed to a vehicle body member and tiltably holding the steering column,
wherein a stress cushioning member is disposed between the steering column and the tilt bracket.

2. The tilt-type steering apparatus according to claim 1, wherein the stress cushioning member is made of a synthetic resin.

3. The tilt-type steering apparatus according to claim 1, wherein the stress cushioning member is fixed to either one of the steering column and the tilt bracket.

4. The tilt-type steering apparatus according to claim 1, wherein a fitting recess is formed on either one of the steering column and the tilt bracket, and the stress cushioning member is fixedly fitted into the fitting recess.

5. The tilt-type steering apparatus according to claim 1, wherein a fitting recess is formed on either one of the steering column and the tilt bracket, and a fitting protrusion formed on the stress cushioning member is fitted into the fitting recess.

6. The tilt-type steering apparatus according to claim 1, wherein a fitting protrusion is formed on either one of the steering column and the tilt bracket, and the fitting protrusion is fitted into a fitting recess formed on the stress cushioning member.

7. The tilt-type steering apparatus according to claim 1, further comprising an electric actuator which tilts the steering column with respect to the tilt bracket.

8. The steering apparatus according to claim 1, wherein the stress cushioning member comprises PTFE resin.
